(19) United States
(12) Patent Application Publication
(10) Pub. No.: US 2011/0311947 A1
(43) Pub. Date: Dec. 22, 2011

(54) Tooth implant with machinable construction

(76) Inventors: Andre Schoene, Bad Sackingen (DE); Andre Schwander, Ruschikon (CH); Marc Stephan, Loerrach (DE)

(21) Appl. No.: 12/309,267

(22) PCT Filed: Jul. 12, 2007
(86) PCT No.: PCT/EP2007/057135

§ 371 Date: Oct. 27, 2009

(30) Foreign Application Priority Data
Jul. 13, 2006 (EP) 06117125.2

(51) Int. Cl. A61C 8/00

(52) U.S. Cl. 433/174; 433/173

(57) ABSTRACT

A dental implant for a prosthetic appliance comprising a region (I) designed for permanent insertion into a jawbone and a connection region (II) adjacent thereto that bears the prosthetic appliance and is characterized in that
said connection region (II) is prefabricated and consists of at least one ceramic region (3) having a core region (3a), and at least one external region (4);
said core region (3a) is at least partially surrounded by said external region (4);
said at least one external region (4) is made of a workable material for the preparation of a prosthetic appliance;
the ceramic material of said ceramic core region (3) has a hardness that is greater than that of the external region (4); and
   the material of the external region (4) has a hardness equal to or less than that of the range of natural enamel.

The present invention relates to a dental implant for prosthetic appliance.

Dental implants have recently been employed to an increasing intent for the prosthetic supply of patients. In doing so, an implant root is implanted into the patient's jawbone. The implant root has a thread on its outside that is introduced into the bone in a self-cutting or displacing manner. In the prior art, different systems have been known.

Above the implant root, there is the implant neck (or implant shoulder). It is provided at the transition from the bone to the gum (gingiva) and mostly has a smooth or slightly grooved surface.

Above the implant neck, the implant head is provided, which bears the dental restoration. For this too, various systems already exist by means of which the crowning or veneer individually fabricated by the dental technician can be successfully attached to the implant.

A survey of the prior art relating to the different systems is described under: Implantat Register BDIZ ISBN: 3-00-012566-3.

Today, implants are basically made of metal or ceramics. There are one-part and multi-part implants, respectively employed in accordance with the situation.

The three-part structure described above has the following consequences:

In the bone, a gap-free engrafting of the implant with the bone is necessary, which requires some time to heal. With the lapse of dwelling time of the implant in the patient, an alteration of the bone often occurs, the age-related bone loss of the patient also playing a role. Further, care is to be taken that infections at the transition between the bone and implant are avoided, which is not always ensured. To the treater and the patient, it is important that the implant gets a primary firmness in the bone immediately after being screwed in, so that engrafting is facilitated. Mechanical stress on the freshly inserted implant, which may occur immediately after the insertion, then leads to poor engrafting or even loss of the implant.

When an implant is designed, attention is also to be paid to thread geometries, which may have a self-cutting or displacing design or represent a combination of these possibilities. The surface structure may be relevant during the healing period. For example, some surface roughness leads to a possibly improved adsorption of osteoblasts.

The turning force with which the implant root is screwed into the bone is also of importance, since bone qualities may vary very highly between patients.

For two-part or multi-part implants, the turning force for the secondary part, for example, the implant neck or implant head, is also to be considered. Usually, the shape of the implant root is conical, but implant roots having a cylindrical design are also employed.

The implant neck region is characterized by the shape and emergence profile from the gingiva. After the implant root has been inserted, the gingiva is laid over the site where the implant has been inserted in the so-called covered healing of the implant, whereas the gingiva is arranged and heals around the implant neck region, which extends beyond the gingiva in this case, in open healing. The “emergence profile”, i.e., the transition from the implant head to the later prosthetic appliance is also critical. In two-part implants, attention is also to be paid to the connection between the implant neck and implant head.

To the patient, the implant head is extremely relevant from an aesthetic point of view, since this is the part mainly responsible for the appearance of the prosthetic appliance. Demands are made on the integration of the implant in the gingiva region with respect to material, color, shape and physiological tolerability. The exposed sites of the prosthetic appliance must be easily cleaned in order to cause the prosthetic appliance to have as many years as possible of service time. Often, it is disadvantageous that the aesthetic appearance of the prosthetic appliance is deteriorated by the fact that bone loss and gingiva retraction have the effect that the implant itself appears and the dental veneer does no longer sufficiently conceal the implant in the aesthetically relevant region. This results in disturbing phenomena because more or less black surfaces appear in the case of metal implants, and unnaturally colored white spots correspondingly appear in ceramic implants. In two-part metallic implants, it is often disadvantageous that the connection between the two parts cannot be created without a gap, which may in turn result in problems of oral hygiene, for example.

Especially in implants in the upper jaw, a so-called angular correction is often necessary after the insertion of the implant, so that an implant should be capable of being reworked after the insertion.

DE 20 2006 002 232 U1 discloses a hybrid implant comprising a screw part and a prosthetic part. The mentioned parts can be made from different ceramic materials or plastic. Indications as to advantages of the use of ceramics for preparing the screw part and the prosthetic part, let alone matching their hardness, are not given.

US 2005/0136378 A1 relates to an implant system for simplified use and insertion that comprises an implant and a prosthetic part. The prosthetic part contains a so-called “abutment” and a means with a collar-like design.

The object of the invention was among others to provide a dental implant that meets the requirements mentioned in the prior art and in addition ensures an improved aesthetic appearance over an extended bearing period. Further, the dental implant should enable an “emergence profile” to be designed in order to allow for an optimum oral hygiene even if the bone is retarded in the course of the bearing time of the implant.

This object is achieved by a dental implant for a prosthetic appliance comprising a region I designed for permanent insertion into a jawbone and a connection region II adjacent thereto that bears the prosthetic appliance and is characterized in that
said connection region II is prefabricated and consists of at least one ceramic region 3 having a core region 3a, and at least one external region 4;
said core region 3a is at least partially surrounded by said external region 4;
said at least one external region 4 is made of a workable material for the preparation of a prosthetic appliance;
the ceramic material of said ceramic core region 3 has a hardness that is greater than that of the external region 4; and
the material of the external region 4 has a hardness equal to or less than that of the range of natural enamel.

The initially mentioned implant neck can be interpreted as a region between region I and the connection region II, wherein the beginning of the connection region II may, but need not, extend into the gingiva region.

In contrast to previously known implants, the dental implant according to the invention allows for an individual design of the implant head. Due to the fact that the external region 4 has a hardness within the range of that of natural enamel or lower, the implant head, which will bear the later prosthetic appliance in its finished form, can be worked with the tools usually employed by the dentist without adversely affecting the patient. With the dental implants consisting of very hard materials, for example, zirconia ceramics, the implant head is very difficult to work, because the working is extremely uncomfortable to the patient because of the necessary intensity, and in addition, due to the vibration and grinding forces, there is also a risk that the implant may be damaged in the root region, which may possibly even lead to a total loss of the implant.

In contrast, the implant according to the invention can be worked simply after insertion or engraftment and prepared for optimum dental-technical care.

In one embodiment of the invention, the region I and the connection region II of the dental implant are integrated as one part.

When the dental implant according to the invention is inserted, it is advantageous to have an embodiment in which the connection region II has a screwing aid at the upper end of the dental implant. For example, interior and exterior interfaces of different geometries, for example, hexagonal or octagonal, are known.

In another embodiment, the region I and the connection region II of the dental implant according to the invention have a multi-part design. The multiple parts allow the user to apply covered healing as well as additional degrees of freedom for any angular correction of the implant structure that should be necessary.

In this case, the region I may have a means for receiving the connection region II, or alternatively, the connection region II may have a means for receiving the region I.

For adjusting and changing the orientation of the implant structure, for example, the connection region may have a rotatable and/or pivotable design. Both predefined change options and freely selectable ones are possible. According to the invention, a “predefined change option” means a measure that allows the relative position of the implant and of the structure to be changed mechanically, for example, by a lock element that provides for locking means at particular angular distances. In particular, the lock element may allow for 1 degree locking. This enables the connection region II to be rotated in fine grades.

Freely selectable change options may also be realized, for example, by a free rotation of the connection region II with fixing the optimum position, for example, by adhesive bonding.

In the dental implant according to the invention, the difference in hardness of the ceramic materials of the ceramic core region and of the external region, if made of a ceramic material, is, for example, 100 HV 1 to 3000 HV 10, expressed in Vickers hardness (DIN EN ISO 6507-1). The transition may be discontinuous or continuous.

The hardness of the ceramics of the ceramic core region is typically from 1000 to 2500 HV 10, especially from 1000 to 1500 HV 10.

The hardness of the material of the ceramic or glassy external region is typically from 250 to 900 HV 1, especially from 500 to 700 HV 1. If the external region is constituted of plastic materials, the hardness is chosen accordingly, for example, Shore D hardness 38 to 104, especially 67 to 91.

The hardness of plastic materials is expressed as Shore D hardness (DIN 53505 and DIN 7868). Conversion tables for different hardness values can be found, for example, in Wikipedia.

Thus, the dentist is able to perform mechanical working with conventional dental devices.

The size and dimension of the external region depends, in particular, on the diameter of the implant and may be adapted to the size of the gap to be covered.

In order to achieve an improved aesthetic impression, the color of the ceramics of the dental implant may be tooth-colored according to known color systems, for example, according to VITA SYSTEM 3D-MASTER, VITAPAN classical.

In a further embodiment of the dental implant according to the invention, the external region may extend into a region covered by the gingiva after the insertion and healing of the dental implant.

Typically, the ceramic material of the ceramic core region of the dental implant according to the invention is made of suitable high strength ceramic materials, for example, nitrides, carbides, oxides, especially zirconia, alumina or combinations thereof.

The material of the external region of the dental implant according to the invention is made of ceramics, glass, plastic materials or combinations thereof, for example, silicate ceramics, glass ceramics, glass, oxide ceramics, infiltration ceramics or combinations thereof. In particular, so-called resin-infiltrated ceramics as disclosed, for example, in WO-A-02/076907 may be mentioned. WO-A-02/076907 is included herein by reference.

The external region may be connected with the ceramic core region by positive, frictional or integral connection.

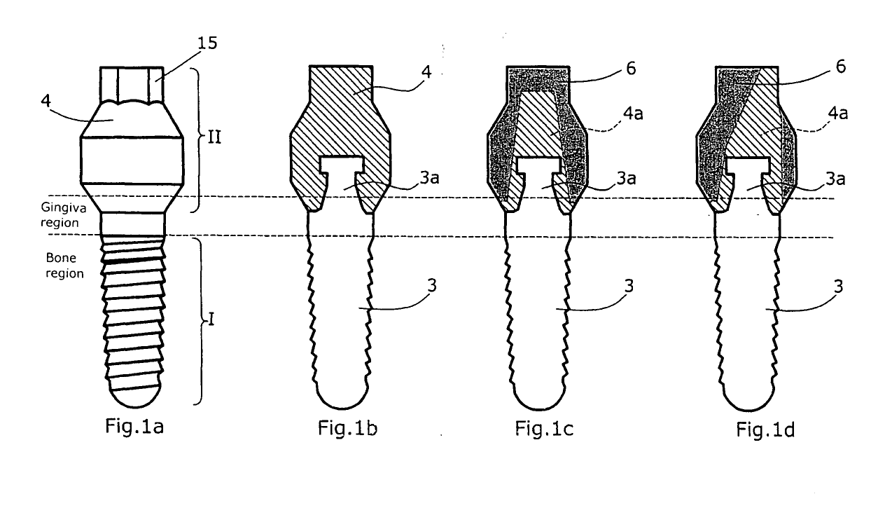

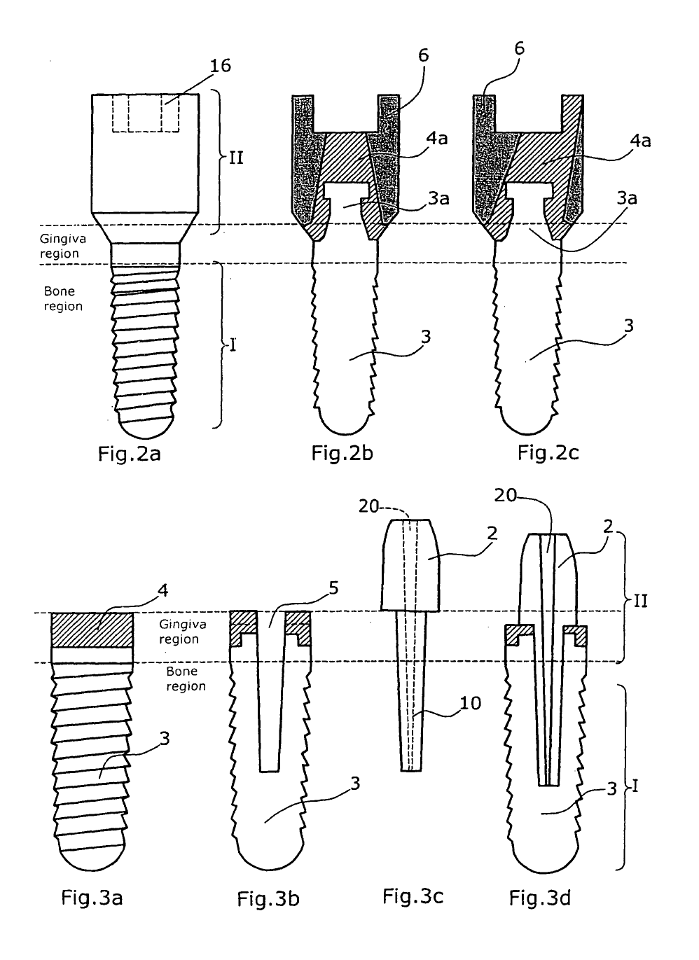

In the Figures, the position of the region designed for permanent insertion into a jawbone and the position of the external region 4 are respectively indicated. The dotted lines indicate the boundaries between the bone region and gingiva and between the gingiva and the oral cavity. The gray shaded areas in FIGS. 1 and 2 schematically indicate the regions removed by mechanical working. The remaining region of the external region 4 serves for application of the external veneer.

FIGS. 1b-d, 2b, c and 3b and d are sectional views through the embodiments of the implant according to FIGS. 1a, 2a, 3a.

FIG. 1a shows a typical integral implant with a workable implant head. The implant root consist of a ceramic material having a high hardness, especially a Vickers hardness of 1000-2500 HV 10 and extends into the interior of the external region 4 as illustrated by FIGS. 1b and 2b. The external region 4 consists of a material, for example, a ceramic material, having a lower Vickers hardness that corresponds, for example, to the hardness of the natural enamel or lower. Typical Vickers hardness values that may be considered here are 500-700 HV 1 or, if plastic materials are employed, 67 to 91 Shore D hardness. The external region 4 surrounds the core region 3a, especially completely, in the region of transition between the implant root and implant neck. The external region 4 may be connected with the ceramic core region 3a by positive, integral or frictional connection, for example, by locking, adhesive bonding or friction.

The embodiment according to FIG. 1a bears a screwing aid 15 at the upper end of the connection region II (head), which may be designed, for example, as a hexagon, other geometries also being possible. In comparison, in FIG. 2a, the screwing aid 16 is designed in the form of a hex socket at the upper end of the implant head. Of course, other designs are possible and known to the skilled person.

FIGS. 1c and 2c schematically show the implant head after grinding by means of conventional grinding devices that are usually present in a dentist's practice, wherein the implant head has been prepared as a trunk for receiving a veneer. The gray shaded regions 6 have been removed during the grinding process. The trunks 4a obtained in the preparation are represented as hatched areas, showing an idealized representation.

Now, the dental technician can prepare working models by means of known impression techniques and build the corresponding prosthetic appliance thereon, which is then fitted into place after being finished.

FIG. 3 relates to an embodiment of a two-part ceramic implant according to the present invention.

FIG. 3a shows a ceramic dental implant that can be embedded in the bone region. In the region of the gingiva, the embodiment of FIG. 3a has an external region 4 made of a material, especially ceramic material, with the degrees of hardness as mentioned above that are equal to or less than those of the natural enamel, i.e., about 500-700 HV 1. In particular, the embodiment according to FIG. 3a has central blind bores 5 as a means for receiving the connection region II. The connection region II has an extension 10, which may be conical, for example. In this case, the blind bore 5 has a complementary design, so that the head part 2 can be inserted into the blind bore with positive connection.

To design a connection between the head part of the implant and the root region, which is in the bone, measures can be taken to effect a bonding between the parts forming the dental implant. In an exemplary manner, FIGS. 3c and 3d show a canal 20 that extends throughout the head part 2, preferably in a vertical and centered direction. After the head part has been inserted into the root part present in the bone, an adhesive composition can be introduced through the canal 20, and thus an integral connection (adhesive bonding) can be prepared.

1. A dental implant for a prosthetic appliance comprising a region (I) designed for permanent insertion into a jawbone and a prefabricated connection region (II) adjacent thereto that bears the prosthetic appliance and is characterized in that
said dental implant consists of at least one ceramic region (3) having a core region (3a), and at least one external region (4);
said core region (3a) is at least partially surrounded by said external region (4);
said at least one external region (4) is made of a workable material for the preparation of a prosthetic appliance;
the ceramic material of said ceramic core region (3) has a hardness that is greater than that of the external region (4); and
the material of the external region (4) has a hardness equal to or less than that of the range of natural enamel.

2. The dental implant according to claim 1, characterized in that the region (I) and the connection region (II) of the dental implant are integrated as one part.

3. The dental implant according to claim 1, characterized in that the connection region (II) has a screwing aid (15, 16) at the upper end of the dental implant.

4. The dental implant according to claim 1, characterized in that the region (I) and the connection region (II) of the dental implant have a multi-part design.

5. The dental implant according to claim 4, characterized in that the region (I) has a means (5) for receiving the connection region (II).

6. The dental implant according to claim 4, characterized in that the connection region (II) has a means for receiving the region (I).

7. The dental implant according to claim 4, characterized in that the connection region (II) has a rotatable and/or pivotable design.

8. The dental implant according to claim 1, characterized in that the external region (4) consists of a ceramic material or glass or combinations thereof.

9. The dental implant according to claim 8, characterized in that the difference in hardness of the ceramic material of the ceramic region (3) and core region (3a) and that of the external region (4) is from 100 HV 1 to 3000 HV 10, expressed in Vickers hardness.

10. The dental implant according to claim 1, characterized in that the hardness of the ceramics of the ceramic region (3) and core region (3a) is from 1000 to 2500 HV 10, especially from 1000 to 1500 HV 10.

11. The dental implant according to claim 1, characterized in that the hardness of the ceramics of the external region (4) is from 250 to 900 HV 1, especially from 500 to 700 HV 10.

12. The dental implant according to claim 1, characterized in that the external region (4) consists of a plastic material or filled plastics.

13. The dental implant according to claim 1, wherein the hardness of the external region made of a plastic material is a Shore hardness of from 38 to 104, especially from 67 to 91.

14. The dental implant according to claim 1, characterized in that the size of the external region (4) is adapted to the size of the gap to be covered.

15. The dental implant according to claim 1, characterized in that the color of the dental implant is tooth-colored.

16. The dental implant according to claim 1, characterized in that the external region (4) extends into a region covered by the gingiva after the insertion and healing of the dental implant.

17. The dental implant according to claim 1, characterized in that the ceramic material of the ceramic region (3) and core region (3a) is made of zirconia, alumina or combinations thereof.

18. The dental implant according to claim 1, characterized in that the external region (4) is made of feldspar ceramics, glass ceramics, glass, infiltration ceramics or combinations thereof.

19. The dental implant according to claim 1, characterized in that the external region (4) is connected with the ceramic core region (3a) by positive, integral or frictional connection.
